(19) United States
(12) Patent Application Publication
(10) Pub. No.: US 2024/0112127 A1
(43) Pub. Date: Apr. 4, 2024

(54) COMPONENT MANAGEMENT SYSTEM AND COMPONENT MANAGEMENT METHOD

(71) Applicant: TOYOTA JIDOSHA KABUSHIKI KAISHA, Toyota-shi (JP)

(72) Inventor: Nobuhiro YOSHIDA, Aichi-ken (JP)

(73) Assignee: TOYOTA JIDOSHA KABUSHIKI KAISHA, Toyota-shi (JP)

(21) Appl. No.: 18/447,546

(22) Filed: Aug. 10, 2023

(30) Foreign Application Priority Data
Oct. 3, 2022 (JP) 2022-159454

(51) Int. Cl. G06Q 10/0835

(52) U.S. Cl. CPC G06Q 10/08355

(57) ABSTRACT

A component management system includes: a delivery plan information acquisition unit that acquires delivery plan information of a component; a prediction unit that predicts occurrence of an abnormal situation in a storage use state of the component; a delivery track record information acquisition unit that acquires delivery track record information of the component; a first influence degree calculation unit that calculates a first impact degree and compares the first impact degree with a threshold; a prediction updating unit that updates prediction of the prediction unit; and a notification unit that notifies an abnormal situation when the prediction updating unit predicts occurrence of an abnormal situation.

### CROSS-REFERENCE TO RELATED APPLICATION

This application claims priority to Japanese Patent Application No. 2022-159454 filed on Oct. 3, 2022, incorporated herein by reference in its entirety.

### BACKGROUND

### 1. Technical Field

The present disclosure relates to a component management system and a component management method.

### 2. Description of Related Art

Japanese Unexamined Patent Application Publication No. 2012-247964 (JP 2012-247964 A) discloses a progress management device. A control unit of the progress management device includes an information processing unit that manages each piece of information. The control unit includes a difference processing unit that calculates a plan value, an actual value, and the like related to a cost and a delivery date for each component, calculates a difference value and the like between the plan cost and the actual cost, and performs a process of extracting the component that meets a condition and information on the difference. The control unit further includes a cause processing unit that performs a process of extracting information of a difference cause pattern related to the extracted component and the difference information and displaying the information on a screen, and a process of enabling a user to specify a difference cause from the information of the difference cause pattern. The control unit further includes a countermeasure processing unit that performs a process of extracting information of a countermeasure related to the specified difference cause and displaying the information on a screen, and a process of enabling a user to specify a countermeasure to be executed from the countermeasure information.

### SUMMARY

Abnormal situations such as load overflow may occur due to various causes such as variations in component delivery time and delay in sorting, and thus it is difficult to predict the abnormal situations. Although it is possible to detect an abnormal situation by monitoring a component storage place with a camera or the like, it is difficult to address the abnormal situation in a timely manner because the operator works in multitasking. JP 2012-247964 A does not disclose predicting the occurrence of an abnormal situation based on the usage status of each storage place after delivery of a component. Accordingly, an object of the present disclosure is to provide a component management system that predicts occurrence of an abnormal situation such as load overflow based on a usage status of a storage place.

A component management system of the present disclosure is a component management system including: a delivery plan information acquisition unit that acquires delivery plan information of a component; a prediction unit that predicts occurrence of an abnormal situation of a storage place usage status of the component based on the acquired delivery plan information of the component; a delivery track record information acquisition unit that acquires delivery track record information of the component; a first influence degree calculation unit that calculates a first influence degree based on a difference between the acquired delivery track record information of the component and the acquired delivery plan information of the component, and compares the first influence degree with a threshold value; a prediction updating unit that updates prediction of the prediction unit based on a comparison result of the calculated first influence degree and the threshold value; and a notification unit that notifies the abnormal situation when the prediction updating unit predicts that the abnormal situation will occur.

With the above configuration, it is possible to provide a component management system that predicts occurrence of an abnormal situation such as load overflow based on a usage status of a storage place.

The component management system of the present disclosure further includes a factor analysis unit that analyzes an occurrence factor of the abnormal situation and causes the first influence degree calculation unit to incorporate the occurrence factor, when it is predicted that the abnormal situation will occur.

With the above configuration, the factor analysis unit can feed back the occurrence factor of the abnormal situation to the first influence degree calculation unit.

The component management system of the present disclosure further includes: the factor analysis unit includes a storage unit storing a learned machine learning device that performs learning when a plurality of training datasets constituted by a combination of an occurrence factor of the abnormal situation and a threshold value of the first influence degree is input to the learned machine learning device; and an arithmetic unit that outputs a threshold value of the first influence degree when an occurrence factor of the abnormal situation is input to the learned machine learning device read from the storage unit.

With the above configuration, machine learning can be used for factor analysis.

The component management system of the present disclosure further includes: a storage track record information acquisition unit that acquires storage track record information of each storage place of the component; and a second influence degree calculation unit that calculates a second influence degree that is a difference between the acquired storage track record information and the acquired delivery plan information, and compares the second influence degree with a threshold value. The prediction updating unit updates the prediction of the prediction unit based on a comparison result of the second influence degree and the threshold value.

With the above configuration, the prediction updating unit can update the prediction at an appropriate timing.

A component management method of the present disclosure is a component management method including: a step of acquiring delivery plan information of a component; a step of predicting occurrence of an abnormal situation of a storage place usage status of the component based on the acquired delivery plan information of the component; a step of acquiring delivery track record information of the component; a step of calculating a first influence degree based on a difference between the acquired delivery track record information of the component and the acquired delivery plan information of the component, and comparing the first influence degree with a threshold value; a step of updating prediction of the step of predicting the occurrence of the abnormal situation, based on a comparison result of the calculated first influence degree and the threshold value; and a step of notifying the abnormal situation when the prediction of the step of predicting the occurrence of the abnormal situation is updated and the abnormal situation is predicted to occur.

With the above configuration, it is possible to provide a component management method for predicting occurrence of an abnormal situation such as load overflow based on a usage status of a storage place.

According to the present disclosure, it is possible to provide a component management system that predicts occurrence of an abnormal situation such as load overflow based on a usage status of a storage place.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a component management system according to a first embodiment;

FIG. 2 is a flowchart of a component management method according to Embodiment 1; and

FIG. 3 is a flowchart of the component management method according to the second embodiment.

### DETAILED DESCRIPTION OF EMBODIMENTS

### First Embodiment

Hereinafter, embodiments of the present disclosure will be described with reference to the drawings. However, the disclosure according to the claims is not limited to the following embodiments. Further, not all of the configurations described in the embodiments are essential as means for solving the problem. For clarity of explanation, the following description and the drawings are omitted and simplified as appropriate. In the drawings, the same elements are denoted by the same reference numerals, and redundant descriptions are omitted as necessary.

### Description of the Component Management System According to Embodiment 1

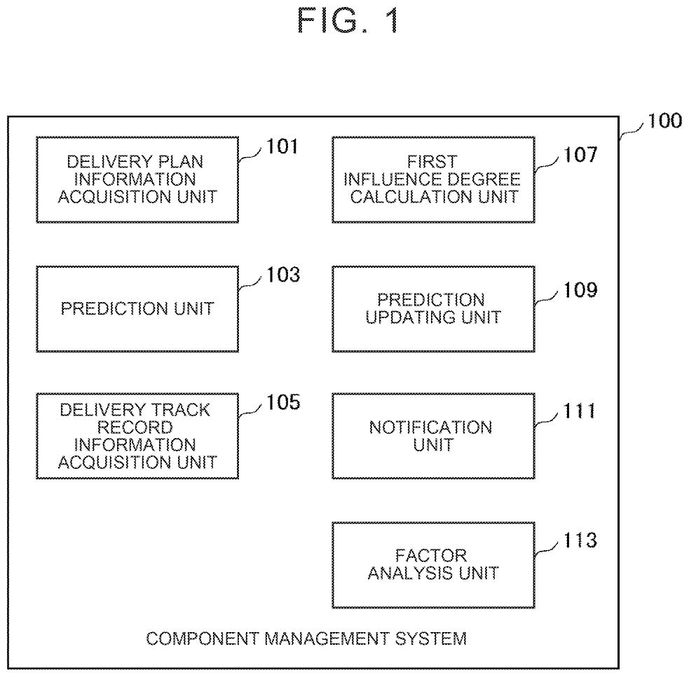

FIG. 1 is a block diagram illustrating a configuration of a component management system according to a first embodiment. A component management system according to Embodiment 1 will be described with reference to FIG. 1. In the first embodiment and the second embodiment to be described later, the overflow of the storage place will be described as an abnormal situation.

As illustrated in FIG. 1, the component management system 100 according to the first embodiment includes a delivery plan information acquisition unit 101, a prediction unit 103, a delivery track record information acquisition unit 105, a first influence degree calculation unit 107, a prediction updating unit 109, and a notification unit 111. Further, the component management system 100 may include a factor analysis unit 113.

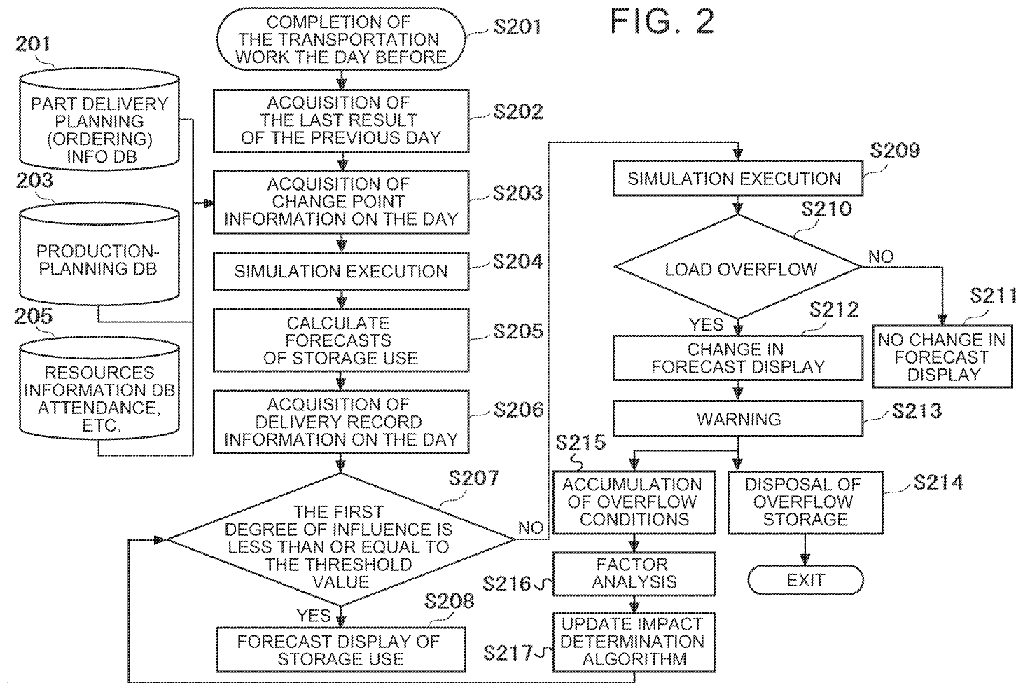

The delivery plan information acquisition unit 101 is a portion having a function of acquiring delivery plan information of a component. The delivery plan information acquisition unit 101 acquires the delivery plan information of the component from the component delivery plan information database 201 (see FIG. 2). The delivery plan information is information in which a part number, a scheduled delivery number, a scheduled delivery time, and the like are associated with each part to be delivered. The volume may be known for each component.

The prediction unit 103 is a portion having a function of predicting occurrence of an abnormal situation in the storage use state of the component based on the acquired delivery plan information of the component. The prediction unit 103 acquires the last result of the previous day. The final results are the usage status of the storage and the stock of parts. The prediction unit 103 acquires the delivery plan information from the delivery plan information acquisition unit 101. Furthermore, the prediction unit 103 acquires the production plan information from the production plan information database 203 (see FIG. 2). The production plan information is information in which a product number, a production scheduled number, a production scheduled date and time, and the like are associated with each product. Furthermore, the prediction unit 103 acquires the resource information such as attendance and attendance of the worker from the resource information database 205 (see FIG. 2). The prediction unit 103 takes in the change point information on the day based on the delivery plan information, the production plan information, and the resource information. The prediction unit 103 executes a simulation based on the final result and the change point information on the day, and outputs a place-use prediction. The prediction unit 103 preferably predicts at the beginning of the day of delivery.

The delivery track record information acquisition unit 105 is a portion having a function of acquiring delivery result information of a component. The delivery track record information acquisition unit sequentially generates delivery result information that is likely to be deviated from the plan, and captures the delivery result information at a predetermined frequency. The delivery record information includes a part number, a delivery time, and the like.

The first influence degree calculation unit 107 is a portion having a function of calculating a first influence degree based on a difference between the acquired delivery result information of the component and the acquired delivery plan information of the component, and comparing the first influence degree with a threshold value. The first influence degree calculation unit 107 determines whether the difference between the scheduled delivery time and the actual delivery time affects the overflow by using an algorithm. As will be described later, the determination threshold can be changed.

The prediction updating unit 109 is a portion having a function of updating the prediction of the prediction unit 103 based on the calculated comparison result between the first degree of influence and the threshold. For example, when the first degree of influence exceeds the threshold value and is determined to have an influence, the prediction updating unit 109 executes prediction updating. The prediction updating unit 109 executes a simulation for predicting the use state of the place in the same manner as the prediction unit 103. The prediction updating unit 109 determines the occurrence of a load overflow based on the simulation. The determination is performed based on a preset threshold value.

The notification unit 111 is a portion having a function of notifying an abnormal situation when the prediction updating unit 109 predicts that an abnormal situation will occur. The notification unit 111 issues a warning by display or voice.

The factor analysis unit 113 is a portion having a function of analyzing a cause of occurrence of an abnormal situation and reflecting the result in the first influence degree calculation unit 107 when it is predicted that an abnormal situation will occur. The factor analysis unit 113 includes a storage unit that stores a learned machine learning device learned by inputting a plurality of training data sets. The training data set is composed of a combination of the occurrence factor of the abnormal situation and the threshold value of the first degree of influence. Further, the factor analysis unit 113 includes an arithmetic unit that outputs a threshold value of the first degree of influence by inputting a cause of occurrence of an abnormal situation to the learned machine learning unit read from the storage unit. That is, the factor analysis unit 113 includes Artificial Intelligence (AI). In this way, machine learning can be used for factor analysis.

The factor analysis unit 113 accumulates the conditions at the time of occurrence of load overflow, and continuously improves the next determination accuracy by using the accumulated conditions for updating the influence determination algorithm. The factor analysis unit 113 changes the determination threshold of the first degree of influence. In this way, the factor analysis unit 113 can feed back the occurrence factor of the abnormal situation to the first influence degree calculation unit 107.

In this way, it is possible to provide a component management system that predicts occurrence of an abnormal situation such as a load overflow based on the use state of the storage. Further, the above-described functions can be realized by using an information processing apparatus. The information processing apparatus can be constituted by one or a plurality of information processing apparatuses. Further, the information processing apparatus may execute some or all of the functions in the cloud.

### A Description of a Component Management Method According to Embodiment 1

FIG. 2 is a flowchart of the component management method according to the first embodiment. A component management method according to Embodiment 1 will be described with reference to FIG. 2.

As shown in FIG. 2, the component management method is started from the end of the transportation operation on the previous day (S201). Next, the component management system 100 acquires the last result of the previous day (S202). The final results are the status of storage use and the quantity of parts stock. Next, the daily change point data is taken into the component management system 100 (S203). The delivery plan information acquisition unit 101 acquires the component delivery plan from the component delivery plan information database. Further, the component management system 100 acquires the production information from the production plan information database. Further, the component management system 100 acquires the resource information such as attendance of the worker from the resource information database. The day change point information is information indicating a change in the number of components in the component place. The change point of the day is obtained from the part delivery plan, production information, and resource information. The prediction unit 103 simulates the storage usage status based on the final result and the daily change point (S204). The prediction unit 103 outputs a prediction of the storage usage status based on the simulation (S205).

Next, the first influence degree calculation unit 107 takes in delivery record data on the day (S206). Acquire delivery record information that is likely to be deviated from the plan at a predetermined frequency. In addition, the result information includes a part number and a delivery time. Next, the first influence degree calculation unit 107 determines whether or not the first impact degree based on the delivery result and the delivery plan is equal to or less than the thresholds (S207). The first influence degree calculation unit 107 may calculate a difference value for each item number and calculate a first influence degree from each difference value. An algorithm is used to determine whether the difference between the scheduled delivery time and the actual delivery time affects the overflow. If it is equal to or less than the thresholds (Yes of S207), no abnormal situation occurs, and the display unit of the component management system 100 displays the storage space use forecast (S208). If it is equal to or greater than the thresholds (in No of S207), an abnormal situation may occur, and the prediction updating unit 109 executes a simulation of the storage use state (S209). The prediction updating unit 109 executes the usage state prediction of the place.

As a result of the simulation, the prediction updating unit 109 determines whether or not a load overflow occurs beyond the capacity of the storage space (S210). Determine whether a load overflow occurs at a preset threshold value. When the overflow does not occur (No of S210), the prediction updating unit 109 does not change the prediction indication (S211). When a load overflow occurs (Yes of S210), the prediction updating unit 109 changes the prediction indication (S212).

Then, the notification unit 111 issues an alert (S213). Next, the worker S214 the staying goods treatment in the overflow storage area, and the component management method ends the treatment in the storage area. On the other hand, the component management method of the first embodiment accumulates the overflow generation condition (S215) and utilizes the overflow generation condition for updating the effect determination algorithm of the subsequent storage. Therefore, the factor analysis unit 113 analyzes the cause of the overflow (S216). At this time, machine learning can be used for the factor analysis. Then, the factor analysis unit 113 updates the influence determination algorithm of the first influence degree calculation unit 107 (S217). By doing so, the factor analysis unit 113 can feed back the generation factor to the first influence degree calculation unit 107.

As described above, it is possible to provide a component management method for predicting occurrence of an abnormal situation such as a load overflow based on the use state of the storage.

### A Description of a Component Management Method According to Embodiment 2

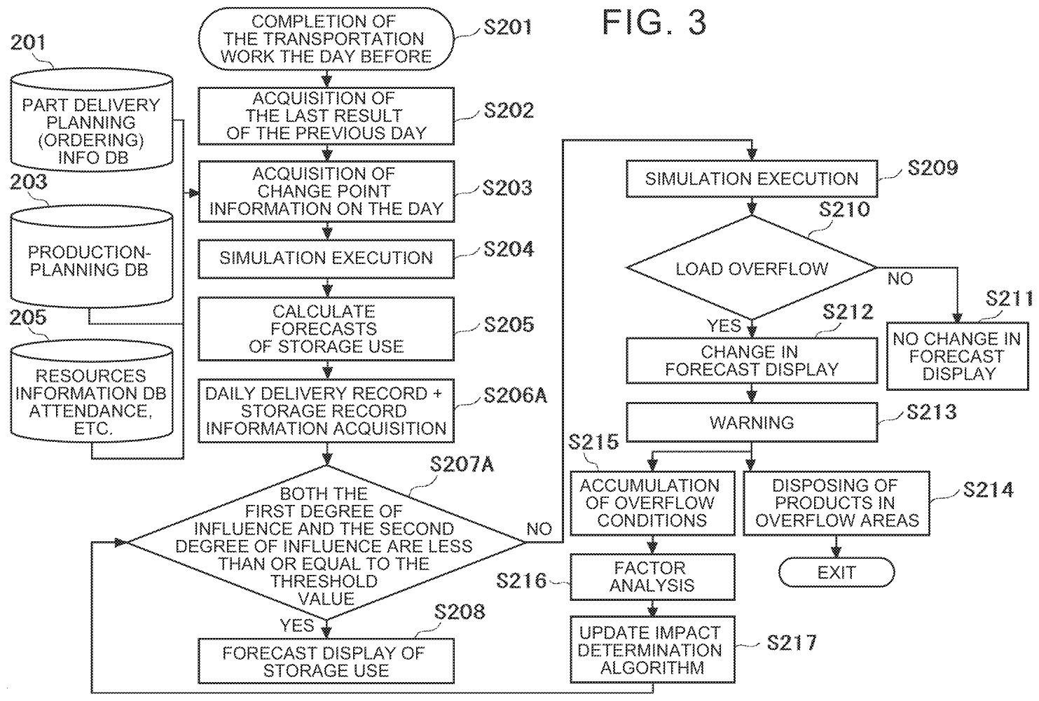

FIG. 3 is a flowchart of the component management method according to the second embodiment. A component management method according to a second embodiment will be described with reference to FIG. 3.

As shown in FIG. 3, Embodiment 2 differs from Embodiment 1 in S206A and S207A. In S206A, the delivery track record information acquisition unit 105 acquires delivery track record information of a component at a predetermined frequency, and the storage track record information acquisition unit acquires the storage track record information. Then, in S207A, it is determined whether or not both of the first impact degree of the delivery result and the delivery plan, the storage result, and the second impact degree of the delivery plan are equal to or less than the thresholds. The second degree of influence is, for example, a difference obtained by subtracting the number of parts of the delivery plan from the number of parts of the storage result. The component management system 100 may calculate the second degree of influence by obtaining a difference value for each component. The first influence degree calculation unit 107 calculates the first influence degree, and the second influence degree calculation unit calculates the second influence degree. On the basis of the comparison between the first degree of influence and the second degree of influence and the threshold value, for example, if both are equal to or less than the threshold value (in Yes of S207A), no abnormal situation occurs, and the display unit of the component management system 100 displays the location use forecast (S208). If any of the thresholds are exceeded (in No of S207A), an anomaly may occur and the component management system 100 simulates the parcel usage (S209).

The factor analysis unit 113 can change not only the first degree of influence but also the threshold value of the second degree of influence. That is, the factor analysis unit 113 can analyze the factor and change the threshold value of the second degree of influence according to the occurrence factor.

By using not only the first degree of influence but also the second degree of influence, the prediction updating unit can update the prediction at an appropriate timing.

In addition, some or all of the processing in the above-described information processing apparatus can be realized as a computer program. Such programs may be stored and provided to a computer using various types of non-transitory computer-readable media. Non-transitory computer-readable media include various types of tangible recording media. Exemplary non-transitory computer-readable media include magnetic recording media (e.g., flexible disks, magnetic tapes, hard disk drives), magneto-optical recording media (e.g., magneto-optical disks), CD-Read Only Memory (ROM), CD-R, CD-R/W, semi-conductor memories (e.g., mask ROM, Programmable ROM (PROM), Erasable PROM (EPROM), flash ROM, Random Access Memory (RAM)). The program may also be supplied to the computer by various types of transitory computer readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

The present disclosure is not limited to the above embodiments, and can be appropriately modified without departing from the spirit thereof.

What is claimed is:

1. A component management system comprising:
a delivery plan information acquisition unit that acquires delivery plan information of a component;
a prediction unit that predicts occurrence of an abnormal situation of a storage place usage status of the component based on the acquired delivery plan information of the component;
a delivery track record information acquisition unit that acquires delivery track record information of the component;
a first influence degree calculation unit that calculates a first influence degree based on a difference between the acquired delivery track record information of the component and the acquired delivery plan information of the component, and compares the first influence degree with a threshold value;
a prediction updating unit that updates prediction of the prediction unit based on a comparison result of the calculated first influence degree and the threshold value; and
a notification unit that notifies the abnormal situation when the prediction updating unit predicts that the abnormal situation will occur.

2. The component management system according to claim 1, further comprising a factor analysis unit that analyzes an occurrence factor of the abnormal situation and causes the first influence degree calculation unit to incorporate the occurrence factor, when it is predicted that the abnormal situation will occur.

3. The component management system according to claim 2, wherein:
the factor analysis unit includes a storage unit storing a learned machine learning device that performs learning when a plurality of training datasets constituted by a combination of an occurrence factor of the abnormal situation and a threshold value of the first influence degree is input to the learned machine learning device; and
the factor analysis unit includes an arithmetic unit that outputs a threshold value of the first influence degree when an occurrence factor of the abnormal situation is input to the learned machine learning device read from the storage unit.

4. The component management system according to claim 1, further comprising:
a storage track record information acquisition unit that acquires storage track record information of each storage place of the component; and
a second influence degree calculation unit that calculates a second influence degree that is a difference between the acquired storage track record information and the acquired delivery plan information, and compares the second influence degree with a threshold value, wherein the prediction updating unit updates the prediction of the prediction unit based on a comparison result of the second influence degree and the threshold value.

5. A component management method comprising:
a step of acquiring delivery plan information of a component;
a step of predicting occurrence of an abnormal situation of a storage place usage status of the component based on the acquired delivery plan information of the component;
a step of acquiring delivery track record information of the component;
a step of calculating a first influence degree based on a difference between the acquired delivery track record information of the component and the acquired delivery plan information of the component, and comparing the first influence degree with a threshold value;
a step of updating prediction of the step of predicting the occurrence of the abnormal situation, based on a comparison result of the calculated first influence degree and the threshold value; and
a step of notifying the abnormal situation when the prediction of the step of predicting the occurrence of the abnormal situation is updated and the abnormal situation is predicted to occur.
